(19) United States
(12) Patent Application Publication
(10) Pub. No.: US 2009/0298348 A1
(43) Pub. Date: Dec. 3, 2009

(54) Contact terminal with contact engaging portion supported by reinforced spring arm

(75) Inventors: Hai-Qiu Lu, ShenZhen (CN); Ji-En Long, ShenZhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/156,057

(22) Filed: May 28, 2008

(51) Int. Cl. H01R 24/04; H01R 13/02

(52) U.S. Cl. 439/668; 439/884

(57) ABSTRACT

An audio jack for receiving a mating plug, comprises insulative housing defining a longitudinal plug-insertion hole therethrough and having a top wall, a bottom wall, a first sidewall, a second sidewall and a rear wall; set of contacts assembled on the insulative housing and including a contact terminal 6 and a stable contact 7, wherein the contact terminal 6 and the stable contact 7 are inserted successively to the rear wall of the insulative housing The contact terminal 6 comprised a base portion 60, a first spring arm 66 extending from an end of the base 60 and having a contact engaging portion 67 located above the base portion 60; and a reinforce arm 65 extending from the base 60 and having a portion located substantially under the contact engaging portion 67 thereby increasing its normal force.

### FIELD OF THE INVENTION

The present invention generally relates to an audio jack used for engaging with an audio plug, And more particularly to a contact terminal with contact engaging portion supported by reinforced spring arm thereby increasing its normal force.

### DESCRIPTIONS OF RELATED ARTS

U.S. Pat. No. 6,478,629B1 issued to Chun Sheng on Nov. 12, 2002 discloses an audio jack includes an insulative casing (6) inside which a movable terminal 4 is disposed. The casing has a front face (60), a rear face (64), a pair of opposite side faces (62, 63); An interior space (601) is defined in the casing. The movable terminal 4 has a plate portion 43 received in the movable terminal holding slot 605, 607, an internal contact portion 41 extending from one end of the plate portion 43, and a solder pad 42 extending out of the casing 6 from a bottom edge of the plate portion 43 for being soldered on the printed circuit board. The internal contact portion 41 of the movable terminal 4 deflectably extends into a middle cavity 604 of the interior space 601. Since the internal contact portion 41 of the movable terminal 4 extend into the middle cavity 604 of the interior space 601, the pin of the mating plug 7 contacts and deflects the internal contact portions 41 of the movable terminals 4. Thus, the internal contact portion 41 of the movable terminal 4 is separated from the internal contact portions 31 of the first and second stationary terminals 1, 3.

An aspect of the invention is to provide a connector with two spring thermals which improves the elasticity of the contact.

### SUMMARY OF THE INVENTION

Accordingly, the object of the present invention is to provide an audio jack for receiving an audio plug, the audio jack having a contact with two spring terminals which improves the elasticity of the contact.

In order to achieve the object set forth, an audio jack of the present invention comprises an audio jack for receiving a mating plug, comprises insulative housing defining a longitudinal plug-insertion hole therethrough and having a top wall, a bottom wall, a first sidewall, a second sidewall and a rear wall; set of contacts assembled on the insulative housing and including a contact terminal and a stable contact, wherein the contact terminal and the stable contact are inserted successively to the rear wall of the insulative housing. A contact terminal comprised a base portion, a first spring arm extending from an end of the base and having a contact engaging portion located above the base portion; and a reinforce arm extending from the base and having a portion located substantially under the contact engaging portion thereby increasing its normal force.

### BRIEF DESCRIPTION OF THE DRAWINGS

FIG. 1 is an assembled perspective view of an audio jack according to a preferred embodiment of the present invention;

FIG. 2 is an exploded perspective view of the audio jack as shown in FIG. 1;

FIG. 3 is another exploded perspective view of the audio jack as show in FIG. 1; and

FIG. 4 is a perspective view of a contact of the audio jack as show in FIG. 1.

### DETAILED DESCRIPTION OF THE INVENTION

Reference will now be made in detail to the preferred embodiment of the present invention.

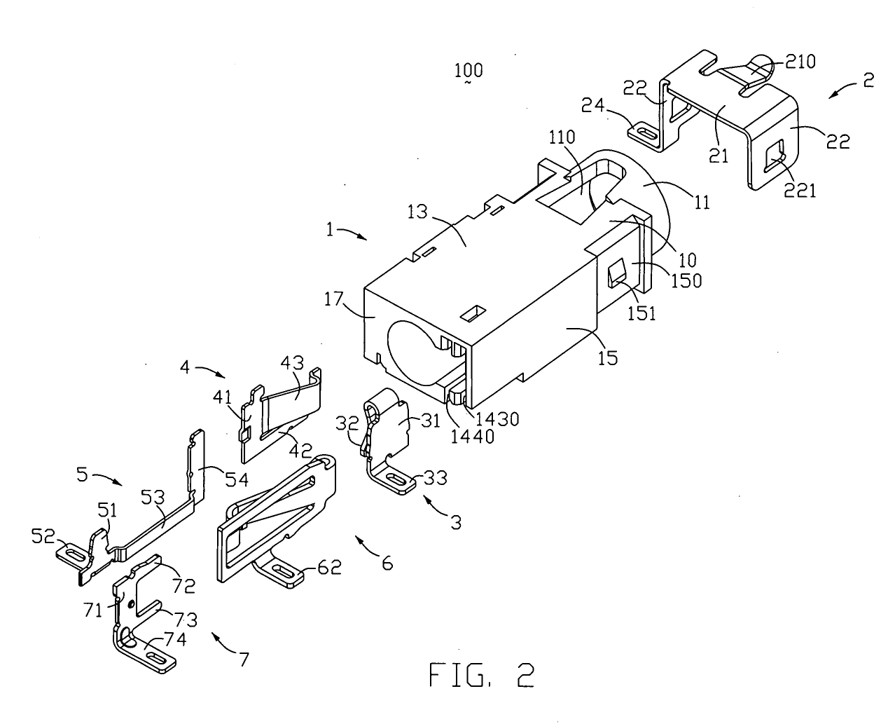

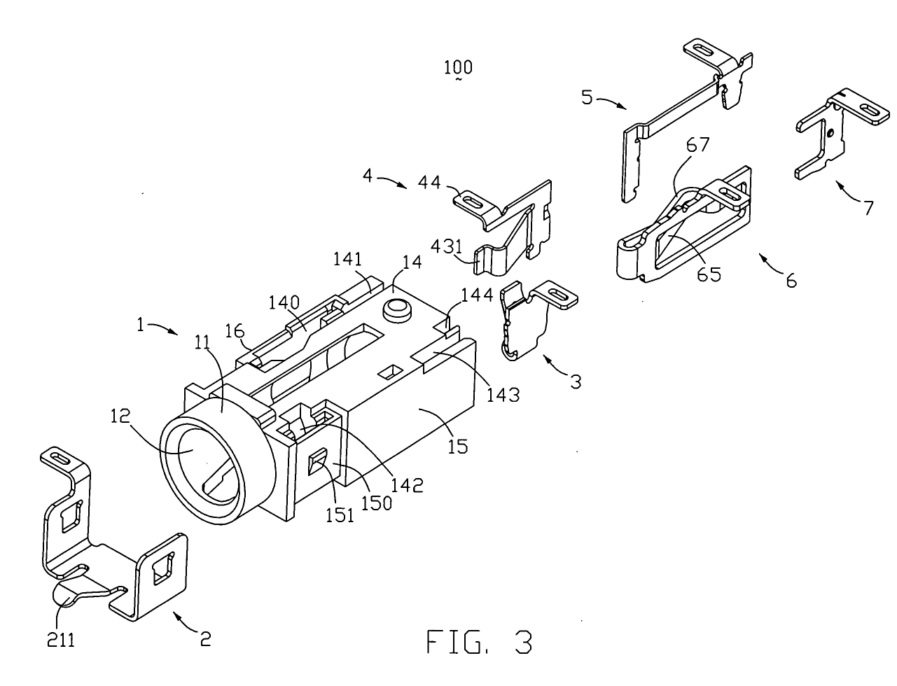

Referring to FIGS. 2 and 3, an audio jack 100 according to the present invention comprises an insulative housing 1 and a set of contacts 2, 3, 4, 5, 6, and 7.

The insulative housing 1 includes a substantially cubical main body 10 and a cylindrical sleeve 11 forwardly extending from a front face of the main body 10. A plug-insertion hole 12 is longitudinally defined through the main body 10 and the sleeve 11 for receiving a mating plug.

The main body 10 has a top wall 13, a bottom wall 14, a first sidewall 15, a second sidewall 16 opposite to the first sidewall 15 and a rear wall 17. A first opening 110 adjacent to the sleeve 11 is defined in the top wall 13, The first opening 110 run through the top wall 13, and both communicate with the plug-insertion hole 12. And a recess 150 is formed at the first sidewall 15 and the second sidewall 16, and a projection 151 protrudes upwardly in the recess 150.

Referring to FIG. 3, the bottom wall 14 forms a first groove 142 communicating with the first opening 110, a second groove 143 adjacent to a corner of the first sidewall 15, a third groove 140 and a fourth groove 141 adjacent to a corner of the second sidewall 16.

Particularly referring to FIG. 2, the rear wall 17 recesses inwardly to form a receiving space 1440 for receiving the stable contact 7. A passageway communicating with the plug-insertion hole 12 extends inwardly from the rear wall 17 along the first sidewall 15. A slot 1430 is defined in the first sidewall 15 and opens to the rear wall 17.

The set of contacts comprises a first contact 2, a second contact 3, a third contact 4 and a fourth contact 5.

The first contact 2 has a first securing portion 21, a first resilient portion 210 extending downwardly at an angle from the top end of the first securing portion 21 and a rectangular first solder tab 24 extending perpendicularly from the bottom end of the sidewall 22 for being surface mounted on a printed circuit board (PCB) (not shown).

The second contact 3 has a second securing portion 31, a second resilient portion 32 extending downwardly at an angle from the top end of the first securing portion 31 and a rectangular second solder tab 33 extending perpendicularly from the bottom end of the second securing portion 31 for being surface mounted on a printed circuit board (PCB) (not shown).

The third contact 4 defines a retain portion 41, and a third spring thermal 43 extending from the middle side of the retain portion 41, the end of the retain portion 41 extended an arm 42.

The fourth contact 5 has a inserted portion 51, the pad 52 extending perpendicularly from the inserted portion 51 for being surface mounted on the PCB, a link portion 53 extending from the side of the inserted portion 51, a contact portion 54 protrudes horizontally from the side of the inserted portion 51.

The contact terminal 6 and a stable contact 7, wherein the contact terminal 6 and the stable contact 7 are inserted successively to the rear wall of the insulative housing. The contact terminal 6 comprised a base portion 60, a first spring arm 66 extending from an end of the base 60 and having a contact engaging portion 67 located above the base portion 60; and a reinforce arm 65 extending from the base 60 and having a portion located substantially under the contact engaging portion 67 thereby increasing its normal force.

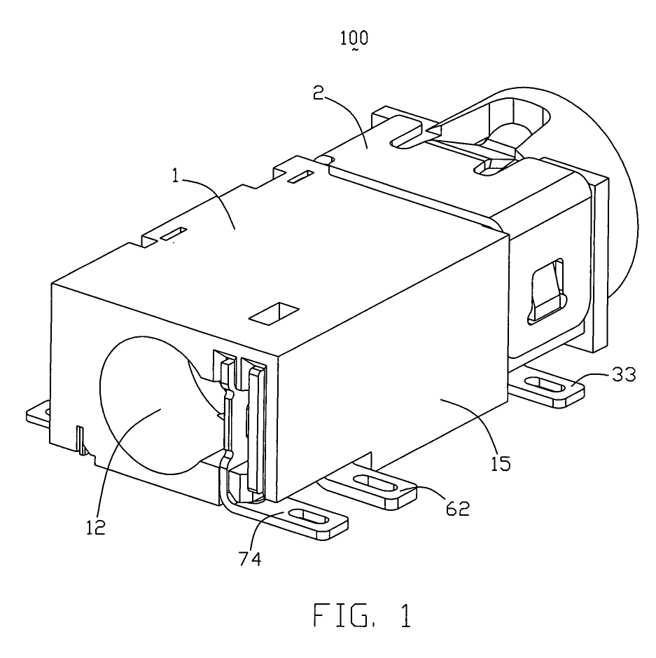

In assembly, with reference to FIGS. 1, 2 and 3, the first contact 2 is retained in the first opening 110 by engagement of the projection 151, The first resilient portion 210 projects inwardly from the top wall 13 into the plug-insertion hole 12. The first solder pad 24 is received in the groove. The second contact 3 is received in the passageway 142. The second barbs are retained in the passageway 142. The second resilient portion 32 extends into the plug-insertion hole 12. The second solder pad 33 is received in the second groove 142. The third contact 4 is retained in the second opening by engagement of the third barbs. The third resilient portion 431 projects inwardly from the second sidewall 16 into the plug-insertion hole 12. The third solder pad 44 is received in the third groove 140. The fourth contact 5 is assembled to the rear wall 17 of the insulative housing 1. The base section 51 is received in the receiving space 141 of the rear wall 17.

A contact terminal 6 and a stable contact 7, wherein the contact terminal 6 and the stable contact 7 are inserted successively to the rear wall of the insulative housing, The contact terminal 6 comprised a base portion 60, a first spring arm 66 extending from an end of the base 60 and having a contact engaging portion 67 located above the base portion 60; and a reinforce arm 65 extending from the base 60 and having a portion located substantially under the contact engaging portion 67 thereby increasing its normal force. Therefore, the insulative housing 1 and the set of contacts 2 are assembled reliably.

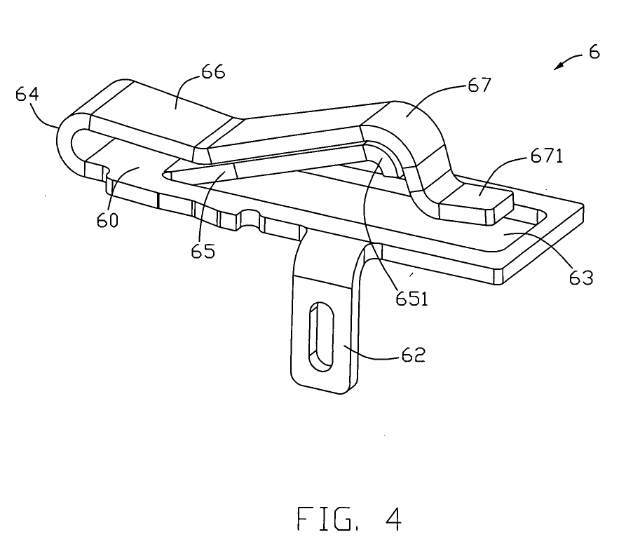

Particularly referring to FIG. 4, when the mating plug is inserted into the housing 1, the first resilient portion 210 of the first contact 2, the second resilient portion 32 of the second contact 3, the third resilient portion 43 of the third contact 4 and the fourth resilient portion 67 of the contact terminal 6 respectively abut against different position of the mating plug 3. Meanwhile, the mating plug pushes the resilient portion 67 and separates the engaging portion 671 of the fourth contact 6 from the contact portion 71 of the stable contact 7.

In the present invention, the second resilient portion 651 upwardly extending from the inside of the hollow frame 60 provide a normal force to improve the elasticity of the contact 67 which will make the audio jack 100 used long enough. Therefore, the present invention overcomes the deficiencies of the conventional audio jacks.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

The novel features of the invention are set forth with particularity in the appended claims. The invention will be best understood from the following description when read in conjunction with the accompanying drawings.

1. A contact terminal comprising:
a base portion;
a pair of spring arms extending upwardly from different positions of the base while in a substantially same curve in an overlapped manner to commonly extend toward a same direction;
wherein the spring arms will move together when the outer spring arm is applied on a downward external force.

2. The contact terminal in accordance with claim 1, wherein a solder tab extending perpendicularly from rear end of the rectangular frame.

3. The contact terminal in accordance with claim 1, wherein a barb for retaining the contact terminal in the housing are respectively formed at the side of the rectangular frame.

4. An audio jack for receiving a mating plug, comprising:
an insulative housing defining a longitudinal plug-insertion bole there through and having a top wail, a bottom wall, a first sidewall, a second sidewall and a rear wall;
a set of contacts assembled on the insulative housing and including a contact terminal and a stable contact, wherein the contact terminal and the stable contact are inserted successively to the rear wall of the insulative housing;
the contact terminal comprising a base portion, a first spring arm and a second spring arm extending upwardly from different positions of the base while in a substantially same curve in an overlapped manner to commonly extend toward a same direction;
wherein both of the first and second spring arms will move away from said plug-insertion hole when the first spring arm is initially applied on a downward external force.

5. The audio jack in accordance with claim 4, wherein a solder tab extending perpendicularly from rear end of the rectangular frame.

6. The audio jack in accordance with claim 5, wherein a barb for retaining the contact terminal in the housing are respectively formed at the side of the rectangular frame.

7. The audio jack in accordance with claim 6, wherein the stable contact has a dimple protruding into a board and contacting the engaging portion.

8. The audio jack in accordance with claim 1, wherein each contact comprises a solder pad, the bottom wall of the insulative housing defines a plurality of grooves for receiving the solder pads of the set of contacts.

9. An audio jack comprising:
an insulative housing defining a longitudinal plug-insertion hole;
a set of contacts assembled on the insulative housing and including a contact terminal;
the contact terminal comprised a base portion, a first spring arm and a second spring arm extending from different positions of the base while in compliantly a substantially same curve in an overlapped manner to commonly extend toward the plug-insertion hole; wherein at least the first spring arm, which is located on an inner side with regard to the second spring arm, invades the plug-insertion hole; wherein
the first spring arm and the second spring arm are both outwardly resiliently deflected in essentially a same radial direction when said first spring arm is engaged by a mating plug which is inserted into the plug-insertion hole.

10. The audio jack as claimed in claim 9, wherein said first spring arm is longer than the second spring ann.

11. The audio jack as claimed in claim 10, wherein said first spring arm is longer than the second spring arm in both two opposite ends.

12. The audio jacket as claimed in claim 9, wherein both said first spring arm and said second spring arm extend in a same axial direction in a side view.

13. The audio jacket as claimed in claim 10, wherein said same axial direction is a front-to-back direction.
